(19) United States
(12) Patent Application Publication
(10) Pub. No.: US 2019/0140413 A1
(43) Pub. Date: May 9, 2019

(54) LIGHT SOCKET DEVICES FOR ONE-HANDED INSTALLATION AND ASSOCIATED SYSTEMS

(71) Applicant: Shining Sea Trading Company, West Valley City, UT (US)

(72) Inventor: Jared Hendricks, Draper, UT (US)

(21) Appl. No.: 16/028,286

(22) Filed: Jul. 5, 2018

Related U.S. Application Data
(60) Provisional application No. 62/528,855, filed on Jul. 5, 2017.

(51) Int. Cl. H01R 33/22

(52) U.S. Cl. CPC H01R 33/22

(57) ABSTRACT

Light socket devices and systems are disclosed and described. A light socket device can include a socket housing including a receiving socket at one end for a light bulb, a clip coupled to the socket housing at an end opposite the receiving socket, the clip further including a clip shaft extending substantially parallel to the socket housing toward the receiving socket and a clip end at a terminal end of the clip shaft. The device can further include a shaped portion of the clip end positioned between the clip and the socket housing, the shaped portion being structurally configured, when pressed against a structural support, to lift the clip end away from the socket housing without manually lifting by an installer.

### PRIORITY DATA

This application claims the benefit of U.S. Provisional Patent Application Ser. No. 62/528,855, filed Jul. 5, 2017, which is incorporated herein by reference.

### BACKGROUND

Decorative lighting is often used to enhance the aesthetic feel of many indoor and outdoor locations. Such lighting can be year-round, seasonal, holiday-related, event-related, and the like. In one example, decorative lighting can be used as a holiday embellishment to decorate interiors, exteriors, trees and shrubs, landscaping structures, floats, displays, and the like.

### BRIEF DESCRIPTION OF THE DRAWINGS

FIG. 1A illustrates a side view of a traditional light socket installation to a support structure;

FIG. 1B illustrates a side view of a light socket installation to a support structure in accordance with an example embodiment;

FIG. 2 illustrates a side view of a light socket device in accordance with an example embodiment;

FIG. 3A illustrates a side view of a light socket clip in accordance with an example embodiment;

FIG. 3B illustrates a front view of a light socket clip in accordance with an example embodiment;

FIG. 3C illustrates a side view of a light socket clip in accordance with an example embodiment;

FIG. 3D illustrates a front view of a light socket clip in accordance with an example embodiment;

FIG. 3E illustrates a side view of a light socket clip in accordance with an example embodiment;

FIG. 3F illustrates a front view of a light socket clip in accordance with an example embodiment;

FIG. 3G illustrates a side view of a light socket clip in accordance with an example embodiment;

FIG. 3H illustrates a front view of a light socket clip in accordance with an example embodiment;

FIG. 4 illustrates a side view of a light socket clip in accordance with an example embodiment;

FIG. 5A illustrates a perspective view of a light socket in accordance with an example embodiment;

FIG. 5B illustrates a perspective view of a light socket in accordance with an example embodiment; and

FIG. 6 illustrates a decorative light system in accordance with an example embodiment.

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals in appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, materials, etc., to provide a thorough understanding of various embodiments. One skilled in the relevant art will recognize, however, that such detailed embodiments do not limit the overall concepts articulated herein, and are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Measurements, sizes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually. This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art

As used herein, “coupled” refers to a relationship of physical connection or attachment between one item and another item, and includes relationships of either direct or indirect connection or attachment. Any number of items can be coupled, such as materials, components, structures, layers, devices, objects, etc.

As used herein, “directly coupled” refers to a relationship of physical connection or attachment between one item and another item where the items have at least one point of direct physical contact or otherwise touch one another. For example, when one layer of material is deposited on or against another layer of material, the layers can be said to be directly coupled.

As used herein, “adjacent” refers to the proximity of two structures or elements. In one example, elements that are identified as being “adjacent” may be either abutting or connected. In another example, such elements may also be near or close to each other without necessarily contacting each other. The exact degree of proximity may in some cases depend on the specific context.

An initial overview of embodiments is provided below, and specific embodiments are then described in further detail. This initial summary is intended to aid readers in understanding the disclosure more quickly, and is not intended to identify key or essential technological features, nor is it intended to limit the scope of the claimed subject matter.

### DETAILED DESCRIPTION OF EXAMPLE EMBODIMENTS

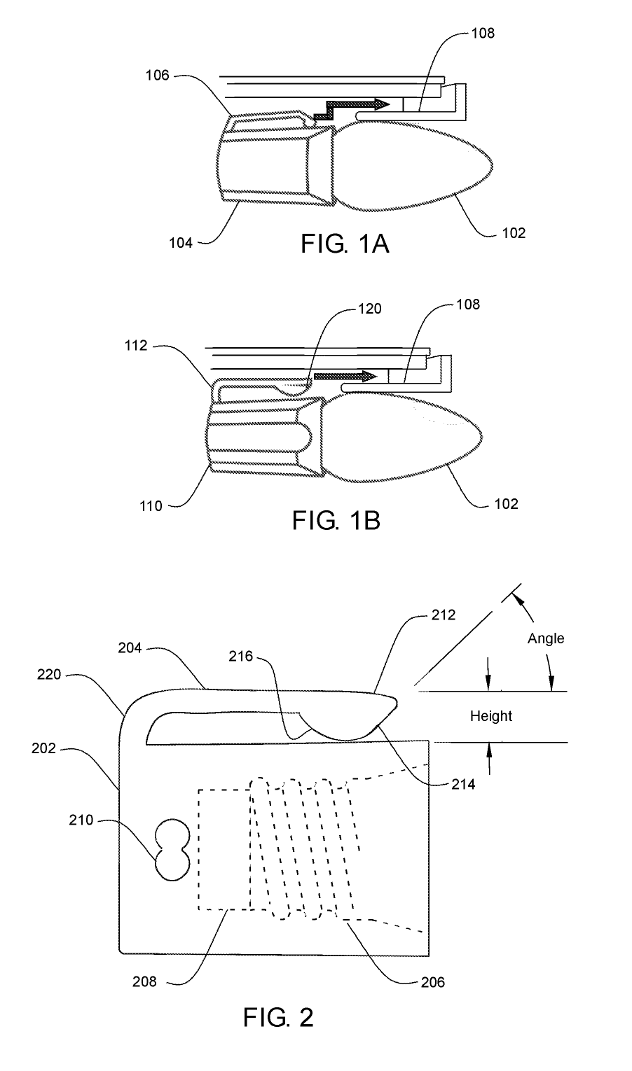

Decorative lighting is often used to enhance the aesthetic feel of many indoor and outdoor locations. Such lighting can be year-round, seasonal, holiday-related, event-related, and the like. In one example, decorative lighting is used as a holiday embellishment on the exteriors of houses, buildings, trees and shrubs, landscaping structures, and the like. It is noted that the description of such lighting on exterior structures does not preclude their use on the inside of houses, buildings, and the like. One challenging aspect involves the hanging of decorative lighting, such as, for example, strings of light sockets with attached bulbs, which in many cases be particularly difficult with exterior structures. One technique that has been previously used involves the attachment of a light socket to a structure by a clip that is coupled to the socket. An individual installing such strings of lights generally climbs to a structure, such as a roofline for example, and proceeds to fasten the light sockets at the clips to the roof line. As illustrated in FIG. 1A, for example, a decorative light 102 is shown engaged in a traditional socket 104, which includes a traditional clip 106 coupled thereto. In order to install the traditional socket 104, the traditional clip 106 must be lifted away from the traditional socket 104 in order to slide over a support structure 108, as shown by the arrow in FIG. 1A. The traditional clip 106 needs to be lifted away from the traditional socket 104 for a number of reasons related to the design of the device. In some traditional clips, the clip end is oriented downward toward the socket, apparently in an attempt to increase the clipping force applied by the clip end. As a result, installing such traditional sockets can be difficult without using two hands. In such two-handed installations, an installer on a ladder is less stable, and thus more prone to accidents, as a result of releasing hold of the ladder to use both hands with every light installed.

The present disclosure provides decorative lighting socket designs that securely attach to various support structures with associated clips that allow for one-handed installation. The sockets can be configured to accept any decorative type of lighting device, bulb, or the like, that can be hung from a support surface. In some examples, the sockets can be coupled together as a string of sockets along an electrical wire. FIG. 1B provides an example showing a decorative light 102 engaged in a light socket 110, which includes a clip 112. The clip 112 has a structural configuration that allows the clip 112 to slide forward and over the support structure 108, as is shown by the arrow in FIG. 1B. The clip 112 contacts the edge of support structure 108 and is lifted away from socket 110 by a combination of the forward movement of the light socket 110 and the shape of the clip 112 where it contacts support structure 108. As the clip 112 contacts the, The clip 112 is thus lifted away from the light socket 110 and over the stationary support structure 108 due to the physical configuration of a forward edge 120 of the clip 112. In the example shown in FIG. 1B, the forward edge 120 has a rounded physical configuration that gradually slides over the support structure 108 as opposed to being blocked by it.

The decorative lighting of the present disclosure can be coupled to any type of support structure capable of engaging the clip. Such can be vertically-oriented support structures, horizontally-oriented structures, or any orientation therebetween. Nonlimiting examples can include roof shingles, roof tiles, fascia, portions of awnings, gutters, rain gutters, soffit, siding, molding, and the like, including associated attachment and decorative hardware.

FIG. 2 illustrates an example of a socket housing 202 including a clip 204 coupled thereto. The clip 204 can be a continuous extension of the socket housing 202 or the clip 204 can be formed separately and subsequently coupled to the socket housing 202. The socket housing 202 includes a threaded socket 206 for accepting a decorative light (not shown), which electrically couples the decorative light to an electrical connection 208 when installed. An electrical wire access 210 provides an opening in the socket housing 202 for passing electrical wires to provide electricity to the decorative light. The clip 204 extends along a side of the socket housing 202 to a clip end 212. In one example, at least an underside surface of the clip 204 is oriented substantially parallel to the socket housing 202 for a substantial portion of its length. Clip end 212 is structurally configured to lift away from the socket housing 202 in response to forward pressure against a support structure. One nonlimiting design feature to accomplish this is through the structural configuration at the clip end 212, which can be any shape capable of causing lift of the clip end in response to forward pressure. Such shapes can be linear or nonlinear, nonlimiting examples of which can include angles, arcs, radii, constant or variable slopes, dish shapes, and the like. In one nonlimiting example, an angle can be formed in the clip end 212 and oriented to facilitate such a lift. An angled portion of the clip end 212 is shown at 214, which can be any angle that facilitates such lift, and can vary according to specific support structure designs. In addition, the clip end 212 can be positioned at a height that allows an upper region of the angled portion 214 to contact an upper surface of the support structure, thus further facilitating lift. The height can be any height that facilitates such lift in combination with the angle, and can vary according to specific support structure designs. In some examples, the clip end 212 can include a shaped portion 216 back to the shaft of the clip 204.

The clipping force applied by the clip end 212 is due, at least in part, to the thickness of the shaft of clip 204, including a thickened portion 220 attaching to the socket housing 202. This is in contrast to traditional clip designs, which attempt to increase force by angling the clip end, and often a portion of the shaft of the clip, downward toward the socket. Other traditional designs include a bend in a clip shaft towards the light socket, followed by an upturned end. This design applies downward force further back from the clip end, which tends to provide a weaker clipping force that allows the clip and socket to rotate and/or slide off the support structure. In addition, the upturned end can cause installation issues in tight spaces by catching on surrounding material, and thus limiting the distance of insertion over the support structure. The present design maintains the downward force at the clip end 212, while minimizing contact with surrounding material. The clip 204 can be manufactured at a height that facilitates attachment to a support structure and maintains a strong clipping force. In addition to the thickness of the attachment 120 and the shaft of the clip 204, in some examples the attachment 120 can be biased with a downward force toward the socket housing 202, such as by a radiused portion of the attachment 120, in order to increase the force applied by the clip end 212.

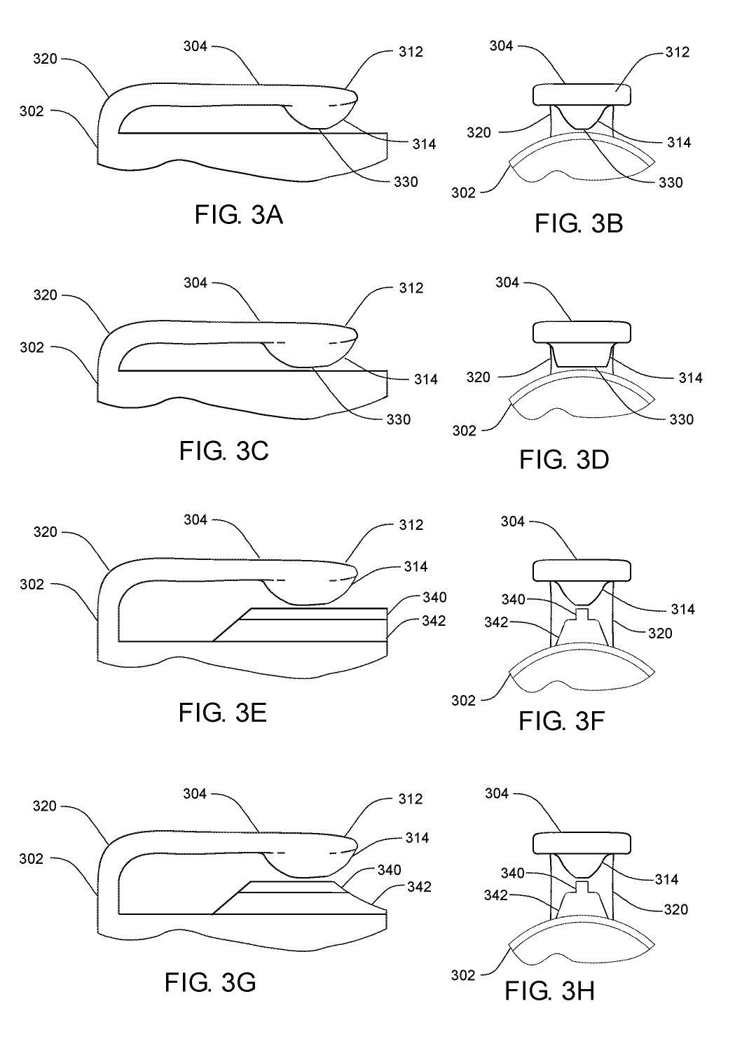

FIGS. 3A-H shows side and front views of various exemplary designs that can facilitate lifting of the clip during light socket installation. FIG. 3A shows side view a socket housing 302 including a clip 304 extending therefrom and running parallel thereto. The portion of the clip 304 extending from the socket housing 302 can include a radiused portion 320. The clip end 312 includes a shaped portion 314 structurally configured to lift away from the socket housing 302 in response to forward pressure against a support structure. In addition, the clip end 312 can be positioned at a height that allows an upper region of the shaped portion 314 to contact an upper surface of the support structure, thus further facilitating lift. The height can be any height that facilitates such lift in combination with the contour of the shaped portion 314 and can vary according to specific support structure designs. FIG. 3B shows a front view of a socket housing 302 with the clip end 312 including the shaped portion 314. The contact region 330 of the shaped portion 314 can vary in design depending on the nature surface to be contacted, the weight of the light and light socket being used, the design of the clip, the amount of downward pressure, and the like. In some examples, the surface area of the contact region 330 can be increased as is shown in FIGS. 3C-D, either in length (FIG. 3C), in width (FIG. 3D), or both.

In some examples, the contact region 330 can rest on the socket housing 302 prior to installation, as is shown in FIGS. 3A-D. In other design examples, as is shown in FIGS. 3E-F, the socket housing 302 can include a clip rest 340 to raise the height of the clip end 312 above the socket housing 302. In this example, the clip rest 340 is shown with a thickened bottom 342 to provide added support to the clip 302, however such is not limiting. In yet another example, as is shown in FIGS. 3G-H, the clip rest 340 and the thickened bottom 342 can be shaped to guide the interface between the clip rest 340 and the shaped portion 314 of the clip end 312 over the support structure.

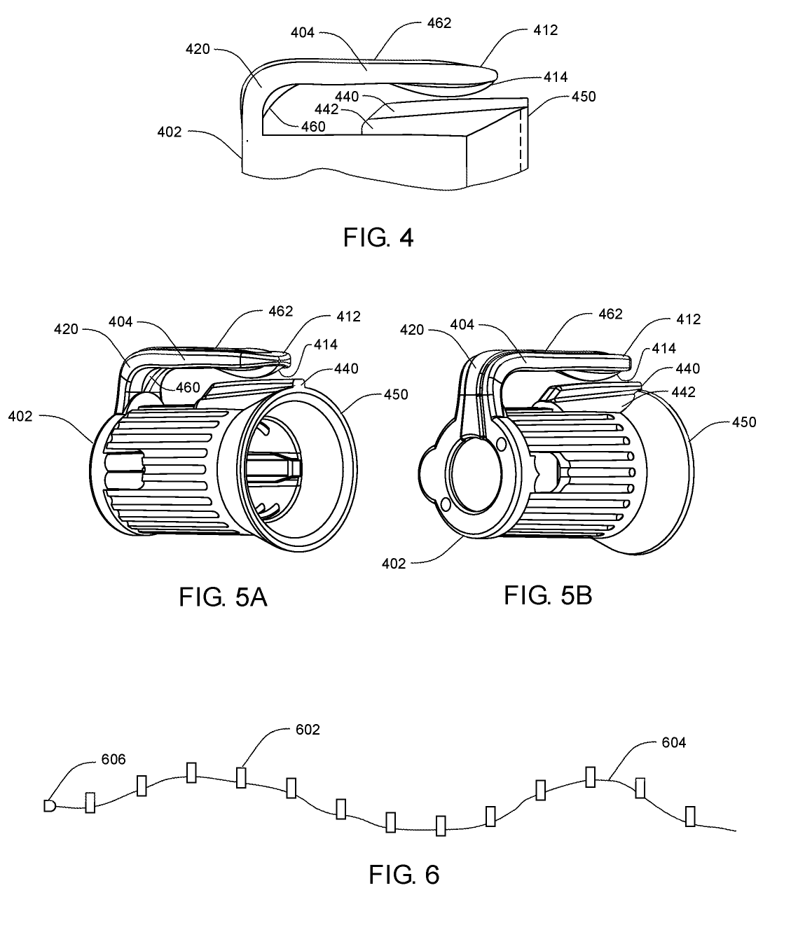

FIG. 4 shows one example of a socket housing 402 including a clip 404 extending from the socket housing 402 by a radiused portion 420 and having a clip end 412 with a shaped portion 414. The socket housing 402 additionally includes a clip rest 440 and a thickened bottom 442, which are shown sloped toward the radiused portion 420. Such a sloped design is merely exemplary, which in some cases can improve the grip of the clip 404 on the structural support. A flare 450 is shown in the socket housing 402 to assist a light bulb into the electrical socket. Various techniques can be utilized to further increase the downward force of the clip end 412 onto the support structure. For example, increasing the stiffness of the clip 404 can accomplish such a force increase. Radial stiffening material 460, for example, can be added to the inside of the radiused portion 420 to not only increase the resistance to upward lift of the clip 404, but also to provide or increase a biased downward force. FIG. 4 additionally shows stiffening material 462 applied along the length of the clip 404, which in some cases can extend downward over the outside of the radiused portion 420. FIGS. 5A-B show perspective views of a socket housing 402 as in FIG. 4 in order to provide a more detailed view of the design.

As has been described, in some examples a plurality of socket housings can be electrically coupled together along electrical wire (e.g., a string of lights). In many cases, a string of lights can include a plug with at least two electrical connection structures, or prongs, configured to insert into an electrical outlet, power supply, surge protector, extension cord, or the like. At least two insulated electrical wires are electrically coupled to the electrical prongs, and extend from the plug with lights spaced along the wires at regular or irregular intervals. In one example, a long continuous wire with lights can be applied to a support structure, such as a roofline, for example, and cut to fit. An electrical plug can then be wired on one or both ends. In other examples, multiple shorter strings of lights can be coupled together in either a parallel or serial wiring scheme. In order to utilize multiple strings of lights with a single electrical connection, the plug can include a socket configured to receive and make electrical contact with the electrical prongs of a plug of another string of lights. When inserted into the socket, the second set of electrical prongs electrically couple to corresponding prong sockets, and thus electrically couple to the electrical connection through the first set of electrical prongs. The region of the plug having the electrical prongs can be referred to as a “male connector,” and the region of the plug having the prong sockets can be referred to as a “female connector.”

FIG. 6 shows an example of a decorative light system that can include a plurality of light socket devices 602 and an electrical wire 604 electrically coupled between each of the plurality of light socket devices 602. The system can additionally include an electrical plug 606 configured to couple to a power source to provide power through the electrical wire 604 to each of the plurality of light socket devices 602.

What is claimed is:

1. A light socket device, comprising:
a socket housing including a receiving socket at one end for a light bulb;
a clip coupled to the socket housing at an end opposite the receiving socket, the clip further comprising:
a clip shaft extending substantially parallel to the socket housing toward the receiving socket; and
a clip end at a terminal end of the clip shaft; and
a shaped portion of the clip end positioned between the clip and the socket housing, the shaped portion being structurally configured, when pressed against a structural support, to lift the clip end away from the socket housing without manually lifting by an installer.

2. The device of claim 1, wherein the clip end is oriented substantially parallel to the socket housing along the clip shaft.

3. The device of claim 1, wherein the clip is a continuous extension of the socket housing.

4. The device of claim 1, further comprising a stiffening material coupled to the clip shaft to increase linear stiffness of the clip.

5. The device of claim 1, wherein the clip further comprises a radiused portion extending from the socket housing to the clip shaft, wherein the radiused portion provides an elastic resistance to the lift of the chip end away from the socket housing.

6. The device of claim 5, wherein the radiused portion extends from the socket housing in a substantially perpendicular direction to the clip shaft and bends to a substantially parallel direction to intersect the clip shaft.

7. The device of claim 5, wherein the radiused portion is biased with a force that directs the clip shaft toward the socket housing.

8. The device of claim 5, further comprising a stiffening material coupled to the radiused portion.

9. The device of claim 5, further comprising a clip rest extending from the socket housing and positioned between the clip end and the socket housing.

10. The device of claim 5, wherein the clip rest includes a forward edge having a structural contour to guide the clip end to a position relative to the structural support facilitate lifting of the clip end.

11. A decorative light system, comprising:
a plurality of light socket devices;
an electrical wire electrically coupled between each of the plurality of light socket devices; and
an electrical plug configured to couple to a power source, wherein each of the plurality of light socket devices further comprises;
a socket housing including a receiving socket at one end for a light bulb;
a clip coupled to the socket housing at an end opposite the receiving socket, the clip further comprising:
a clip shaft extending substantially parallel to the socket housing toward the receiving socket; and
a clip end at a terminal end of the clip shaft; and
a shaped portion of the clip end positioned between the clip and the socket housing, the shaped portion being structurally configured, when pressed against a structural support, to lift the clip end away from the socket housing without manually lifting by an installer.

12. The system of claim 1, wherein the clip end is oriented substantially parallel to the socket housing along the clip shaft.

13. The system of claim 1, wherein the clip is a continuous extension of the socket housing.

14. The system of claim 1, further comprising a stiffening material coupled to the clip shaft to increase linear stiffness of the clip.

15. The system of claim 1, wherein the clip further comprises a radiused portion extending from the socket housing to the clip shaft, wherein the radiused portion provides an elastic resistance to the lift of the chip end away from the socket housing.

16. The system of claim 15, wherein the radiused portion extends from the socket housing in a substantially perpendicular direction to the clip shaft and bends to a substantially parallel direction to intersect the clip shaft.

17. The system of claim 15, wherein the radiused portion is biased with a force that directs the clip shaft toward the socket housing.

18. The system of claim 15, further comprising a stiffening material coupled to the radiused portion.

19. The system of claim 15, further comprising a clip rest extending from the socket housing and positioned between the clip end and the socket housing.

20. The system of claim 15, wherein the clip rest includes a forward edge having a structural contour to guide the clip end to a position relative to the structural support facilitate lifting of the clip end.
